(19) United States
(12) Patent Application Publication
(10) Pub. No.: US 2009/0212256 A1
(43) Pub. Date: Aug. 27, 2009

(54) ELECTROLUMINESCENT PHOSPHOR AND METHOD OF MAKING

(76) Inventors: Gregory Allan Marking, Sayre, PA (US); Xianzhong Chen, Sayre, PA (US); Shellie Kaye Northrop, Sayre, PA (US)

Correspondence Address: Ballard Spahr Andrews & Ingersoll, LLP, SUITE 1000, 999 PEACHTREE STREET, ATLANTA, GA, 30309-3915, US

(21) Appl. No.: 12/393,690

(22) Filed: Feb. 26, 2009

Related U.S. Application Data
(60) Provisional application No. 61/031,515, filed on Feb. 26, 2008.

(51) Int. Cl. C09K 11/54

(52) U.S. Cl. 252/301.6 S

(57) ABSTRACT

A copper activated zinc sulfide electroluminescent phosphor is disclosed, wherein the phosphor comprises greater than about 1,000 ppm copper. Also disclosed is a copper activated zinc sulfide electroluminescent phosphor having a y color coordinate of at least about 0.480. A method for preparing the copper activated zinc sulfide electroluminescent phosphor is disclosed, comprising contacting a zinc sulfide, a first copper source, a magnesium source, and a lithium halide to form a first mixture; heating the mixture at a temperature and for a time sufficient to form a fired mixture; subjecting the fired mixture to a shear force capable of inducing a plurality of defects in the zinc sulfide lattice structure; and then contacting the fired mixture with a second copper source and a zinc oxide to form a second mixture; heating the second mixture at a temperature and for a time sufficient to form a second-fired material.

### CROSS REFERENCE TO RELATED APPLICATIONS

This applications claims priority to U.S. Provisional Application Ser. No. 61/031,515, filed Feb. 26, 2008, which is hereby incorporated by reference.

### BACKGROUND OF THE INVENTION

1. Field of the Invention

The present invention relates to zinc sulfide based electroluminescent (EL) phosphors, and specifically to green emitting EL phosphors with high Cu concentrations and high y color coordinates.

2. Technical Background

Copper activated zinc sulfide electroluminescent (EL) phosphors (ZnS:Cu) are known. Exemplary zinc sulfide phosphors and methods of manufacture are described in U.S. Pat. Nos. 4,859,361, 5,702,643, and 6,248,261. U.S. Pat. No. 4,859,361 describes the general procedure for making ZnS based EL phosphors.

Copper, when present as an activator in zinc sulfide electroluminescent phosphors, is typically in the 1⁺ oxidation state. Copper ions incorporated into such electroluminescent phosphors can occupy Zn²⁺ lattice sites, interstitial positions, and/or in crystal defect regions in the form of Cu₂S precipitates. Such copper ions located in a ZnS crystal lattice can serve varying functions in making ZnS:Cu materials electroluminescent. The overall concentration of copper in an EL phosphor can affect such properties as brightness, maintenance, and color emission. For example, an EL phosphor having a high copper content can exhibit a high y color coordinate, providing a green emission that can be useful in certain applications.

It would be advantageous to have copper activated zinc sulfide electroluminescent materials with a wide range of copper concentrations; however, the solubility of copper in ZnS is limited and existing materials have copper concentrations of less than 1,000 ppm.

Thus, there is a need to address the aforementioned problems and other shortcomings associated with the traditional electroluminescent phosphor materials. These needs and other needs are satisfied by the compositions and methods of the present invention.

### SUMMARY OF THE INVENTION

The present invention relates to zinc sulfide based electroluminescent (EL) phosphors, and specifically to green emitting EL phosphors with high Cu concentrations and high y color coordinates.

In a first aspect, the present invention provides a copper activated zinc sulfide electroluminescent phosphor comprising greater than about 1,000 ppm copper.

In a second aspect, the present invention provides a copper activated zinc sulfide electroluminescent phosphor having a y color coordinate of at least about 0.480.

In a third aspect, the present invention provides a method for preparing a copper activated zinc sulfide electroluminescent phosphor, the method comprising contacting a zinc sulfide, a first copper source, a magnesium source, and a lithium halide to form a first mixture; heating the mixture at a temperature and for a time sufficient to form a fired mixture; subjecting the fired mixture to a shear force capable of inducing a plurality of defects in the zinc sulfide lattice structure; and then contacting the fired mixture with a second copper source and a zinc oxide to form a second mixture; and then heating the second mixture at a temperature and for a time sufficient to form a second-fired material.

Additional aspects and advantages of the invention will be set forth, in part, in the detailed description and any claims which follow, and in part will be derived from the detailed description or can be learned by practice of the invention. The advantages described below will be realized and attained by means of the elements and combinations particularly pointed out in the appended claims. It is to be understood that both the foregoing general description and the following detailed description are exemplary and explanatory only and are not restrictive of the invention as disclosed.

### DETAILED DESCRIPTION OF THE INVENTION

The present invention can be understood more readily by reference to the following detailed description, examples, and claims, and their previous and following description. However, before the present compositions, articles, devices, and methods are disclosed and described, it is to be understood that this invention is not limited to the specific compositions, articles, devices, and methods disclosed unless otherwise specified, as such can, of course, vary. It is also to be understood that the terminology used herein is for the purpose of describing particular aspects only and is not intended to be limiting.

The following description of the invention is provided as an enabling teaching of the invention in its currently known embodiments. To this end, those skilled in the relevant art will recognize and appreciate that many changes can be made to the various aspects of the invention described herein, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

Disclosed are materials, compounds, compositions, and components that can be used for, can be used in conjunction with, can be used in preparation for, or are products of the disclosed method and compositions. These and other materials are disclosed herein, and it is understood that when combinations, subsets, interactions, groups, etc. of these materials are disclosed that while specific reference of each various individual and collective combinations and permutation of these compounds may not be explicitly disclosed, each is specifically contemplated and described herein. Thus, if a class of substituents A, B, and C are disclosed as well as a class of substituents D, E, and F and an example of a combination embodiment, A-D is disclosed, then even if each is not individually recited, each is individually and collectively contemplated. Thus, in this example, each of the combinations A-E, A-F, B-D, B-E, B-F, C-D, C-E, and C-F are specifically contemplated and should be considered disclosed from disclosure of A, B, and C; D, E, and F; and the example combination A-D. Likewise, any subset or combination of these is also specifically contemplated and disclosed. Thus, for example, the sub-group of A-E, B-F, and C-E are specifically contemplated and should be considered disclosed from disclosure of A, B, and C; D, E, and F; and the example combination A-D. This concept applies to all aspects of this disclosure including, but not limited to components of the compositions and steps in methods of making and using the disclosed compositions. Thus, if there are a variety of additional steps that can be performed it is understood that each of these additional steps can be performed with any specific embodiment or combination of embodiments of the disclosed methods, and that each such combination is specifically contemplated and should be considered disclosed.

In this specification and in the claims which follow, reference will be made to a number of terms which shall be defined to have the following meanings:

As used herein, the singular forms “a,” “an” and “the” include plural referents unless the context clearly dictates otherwise. Thus, for example, reference to a “component” includes aspects having two or more such components, unless the context clearly indicates otherwise.

“Optional” or “optionally” means that the subsequently described event or circumstance can or cannot occur, and that the description includes instances where the event or circumstance occurs and instances where it does not. For example, the phrase “optionally present component” means that the component can or can not be present and that the description includes both aspects of the invention where the optional component is present and where the optional component is not present.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As used herein, a “wt. %” or “weight percent” or “percent by weight” of a component, unless specifically stated to the contrary, refers to the ratio of the weight of the component to the total weight of the composition in which the component is included, expressed as a percentage.

The term brightness, as used herein, is intended to refer to the brightness of a phosphor in a conventional thick-film electroluminescent lamp operated at about 100 V and about 400 Hz for about 24 hours.

The terms halflife or half-life, as used herein, are intended to refer to lamp operating time between the time when a 24 hour brightness measurement is made and the time when the lamp brightness drops to a level of 50% of the initial value.

As used herein, the terms x coordinate and y coordinate refer to color coordinates for the 1931 Commission Internationale de l'Eclairage (CIE) Standard Observer (2°).

The following U.S. patents and published applications describe various compositions and methods for preparing lamps comprising electroluminescent materials, and they are hereby incorporated by reference in their entirety and for the specific purpose of disclosing materials and methods relating to the preparation of electroluminescent lamps: U.S. Pat. No. 7,354,785; U.S. Pat. No. 6,309,764; U.S. Pat. No. 4,853,594; U.S. Pat. No. 6,476,552; U.S. Pat. No. 5,976,613; and U.S. Patent Publication No. 2007/0172580.

As briefly introduced above, the present invention provides copper activated zinc sulfide electroluminescent phosphor materials having variable copper content, together with methods for making such phosphors.

As described above, when present as an activator in zinc sulfide EL phosphors, copper is typically in the 1⁺ oxidation state. Copper ions incorporated into ZnS:Cu phosphors can occupy Zn²⁺ lattice sites, interstitial positions, and/or crystal defect regions in the form of Cu₂S precipitates. While higher copper concentrations can provide enhanced control over phosphor properties such as, for example, brightness, maintenance, and color emission, the large ionic radii of copper compared to zinc limits the solubility of copper in the ZnS lattice. In addition, simply adding more copper during the firing stage will not typically result in any appreciable increase in copper incorporation in the ZnS lattice. In fact, excessive copper added in this manner can form CuₓS on the surface of the phosphor particles and must be removed by subsequent washing steps.

Thus, conventional manufacturing techniques have limited the concentration of copper in ZnS materials to less than about 1,000 ppm. The present invention provides ZnS:Cu phosphors having copper concentrations greater than about 1,000 ppm that can exhibit high y color coordinates and thus, provide desirable green emission suitable for use in various applications.

In various aspects, the methods of the present invention comprise the use of a Li containing flux during the first of two firing steps. While not wishing to be bound by theory, it is believed that the small ionic radius of lithium can allow lithium ions to occupy interstitial sites in the ZnS lattice more readily than other ions, such as sodium, without significantly distorting the ZnS crystal structure. Such interstitial lithium ions will not displace existing lattice ions, but will induce a net positive charge into the ZnS lattice. The net positive charge on the lattice can then facilitate the replacement of at least a portion of the Zn²⁺ ions with Cu⁺ ions, reducing the overall positive charge. Thus, through the introduction of interstitial Li⁺ ions, a greater concentration of Cu⁺ can be doped into the lattice.

Similarly, Cl⁻ ions can be used to compensate a reduced positive charge in a ZnS lattice structure. For example, to compensate a reduced positive charge, such as can occur when replacing a portion of the Zn^{2|} ions with Cu^{|} ions, a portion of the S²⁻ anions can be replaced by Cl⁻ ions to reduce the negative charge on the lattice. Thus, Cl⁻ and Cu⁺ can form donor-acceptor (D-A) pairs in zinc sulfide based phosphors. Such D-A pairs can be useful in providing electroluminescent properties to the phosphor material, and, in various aspects, can provide improved brightness over traditional materials.

### Method for Preparing Inventive Phosphor

In various aspects, the method of the present invention comprises contacting zinc sulfide, a copper source, a magnesium source, lithium halide, and optionally zinc oxide, sulfur, sodium chloride, and/or barium chloride to form a mixture; firing the mixture; optionally water washing and drying the fired mixture, milling the optionally dried powder to induce lattice defects; washing and optionally drying the milled material; and then contacting the washed and optionally dried material with zinc oxide and a copper source to form a second mixture, firing the second mixture, and then washing, optionally drying and sifting the fired second mixture. Each of the steps and components are specifically addressed in detail herein.

For each of the materials recited herein that can be used in the preparation of a phosphor material, the physical form and purity can vary. In one aspect aspect, any one or more of the components has a purity of greater than about 95, 98, 99, 99.5, 99.9 or 99.9% or more. In another aspect, each of the components has a purity of greater than about 95, 98, 99, 99.5, 99.9 or 99.9% or more. In another aspect, any one or more of the components has a purity of at least about 99.99%. In yet another aspect, the concentration of any individual impurity, if present, in a component comprises less than about 25, 10, 5, 4, 3, 2, or 1 ppm. In various preferred aspects, a component comprises less than about 5 ppm or less than about 1 ppm of any individual impurity, such as, for example, iron.

The zinc sulfide of the present invention can comprise any zinc sulfide suitable for use in forming an electroluminescent phosphor. In one aspect, the zinc sulfide comprises a powder. In various specific aspects, a zinc sulfide powder has an average particle size of from about 2 μm to about 7 μm, for example, about 2, 2.5, 3, 3.5, 4, 4.5, 5, 5.5, 6, 6.5, or 7 μm. In other aspects, a zinc sulfide can comprise a powder having a particle size of less than about 2 μm or greater than about 7 μm, and the present invention is not intended to be limited to any particular zinc sulfide particle size. It should be appreciated that powder materials, such as, for example, zinc sulfide, can exhibit distributional properties, and that the average and/or range of particle sizes within a material can vary. In one aspect, the zinc sulfide or at least a portion thereof comprises a cubic lattice structure. The amount of zinc sulfide present in the mixture can also vary depending on the desired properties of the final phosphor material. In various aspects, the amount of zinc sulfide present in the mixture can range from about 70 to about 98 wt. %, for example, about 70, 75, 80, 85, 90, 95, or 98 wt. %; from about 79 to about 92 wt. %, for example, about 79, 80, 81, 82, 83, 84, 85, 86, 87, 88, 89, 90, 91, or 92 wt. %; or from about 83 to about 88 wt. %; for example, about 83, 84, 85, 86, 87, or 88 wt. %. In other aspects the amount of zinc sulfide present in the mixture can comprise 79.7, 80.5, 81.6, 83.2, 85.4, 86.4, 87.2, 88.5, 89.0, 90.6, 91.3, or 92 wt %. In a preferred aspect, the amount of zinc sulfide present in the mixture comprises about 85.4 wt. %. It should be appreciated that the amount of zinc sulfide present in a mixture can vary based on, for example, the purity of the zinc sulfide, concentration of other components, and desired phosphor properties. In other aspects, the amount of zinc sulfide present in the mixture can be less than about 70 wt. % or greater than about 98 wt. %, and the present invention is not intended to be limited to any particular zinc sulfide concentration. Zinc sulfide materials are commercially available and one of skill in the art could readily select an appropriate zinc sulfide for an intended application.

The zinc oxide of the present invention can comprise any zinc oxide material suitable for use in forming an electroluminescent phosphor. In various aspects, the zinc oxide material can comprise ZnO, ZnSO₄, ZnCO₃, or a combination thereof. In a preferred aspect, the zinc oxide material comprises ZnO. In one aspect, the zinc oxide material comprises a powder.

The amount of zinc oxide material present in the mixture can also vary depending on the specific chemical composition of the zinc oxide material, and/or the desired properties of the final phosphor material. In one aspect, the amount of zinc oxide material to be contacted can be split between the mixture prior to firing and the second mixture. In one aspect, the amount of zinc oxide material contacted with the mixture prior to firing is less than the amount of zinc oxide material contacted with the second mixture. In another aspect, all or substantially all of the zinc oxide material is contacted with the second mixture. In another aspect, no or substantially no zinc oxide material is contacted with the mixture prior to firing. In a specific aspect, no zinc oxide material is contacted with the mixture prior to firing and all of the zinc oxide material is contacted with the second mixture. If the zinc oxide material is split such that a portion is contacted with each of the mixture prior to firing and with the second mixture, it is not necessary that the zinc oxide materials comprise the same chemical composition or exhibit the same properties, and both aspects wherein the zinc oxide contacted with the mixture prior to firing and the zinc oxide contacted with the second mixture are the same and are different are contemplated. While not wishing to be bound by theory, it is theorized that the presence of a zinc oxide material can improve brightness of the resulting phosphor material.

In various aspects, the amount of zinc oxide in the mixture prior to firing can range from about 0 to about 1 wt. %, for example, about 0, 0.05, 0.08, 0.1, 0.2, 0.3, 0.4, 0.5, 0.6, 0.8, or 1 wt. %; from about 0.2 to about 0.6 wt. %, for example, about 0.2, 0.3, 0.4, 0.5, or 0.6 wt. %; or from about 0.3 to about 0.5 wt. %, for example, about 0.3, 0.35, 0.4, 0.45, or 0.5 wt. %. In a specific aspect, the amount of zinc oxide present in the mixture prior to firing comprises about 0.4 wt. %. In other aspects, the amount of zinc oxide present in the mixture prior to firing, if present, can be greater than about 1 wt. % and the present invention is not intended to be limited to any particular zinc oxide concentration. Zinc oxide materials are commercially available and one of skill in the art could readily select an appropriate zinc oxide for an intended application.

The copper source of the present invention can comprise any copper source suitable for use in forming an electroluminescent phosphor. In one aspect, the copper source comprises any one or more copper containing materials capable of delivering a copper ion to a ZnS crystal lattice. In various aspects, the copper source can comprise a copper (II) sulfate, copper acetate, copper carbonate, copper nitrate, copper chloride, or a combination thereof. In a preferred aspect, the copper source comprises a copper (II) sulfate (CuSO₄). In one aspect, the copper source comprises an anhydrous material, such as, for example, anhydrous copper sulfate. In another aspect, all elements present in the copper source, other than copper and oxygen, can escape, for example, by volatilization, during the heating and/or firing process.

The amount of copper present in the mixture prior to firing can also vary depending on the desired properties of the final phosphor material. In various aspects, the amount of a copper source present in the mixture can range from about 0.01 to about 1 wt. %, for example, about 0.01, 0.02, 0.03, 0.04, 0.05, 0.06, 0.08, 0.1, 0.12, 0.14, 0.16, 0.18, 0.2, 0.22, 0.24, 0.25, 0.4, 0.6, 0.8, or 1 wt. %; from about 0.06 to about 0.4 wt. %, for example, about 0.06, 0.08, 0.1, 0.12, 0.14, 0.16, 0.18, 0.2, 0.24, 0.28, 0.32, 0.36, or 0.4 wt. %; or from about 0.1 to about 0.3 wt. %, for example, about 0.1, 0.15, 0.2, 0.25, or 0.3 wt. %. In a specific aspect, the amount of copper source present in the mixture can comprise about 0.2 wt. %. In other aspects, the amount of a copper source present in the mixture can be less than about 0.01 wt. % or greater than about 1 wt. %, and the present invention is not intended to be limited to any particular copper source concentration. In another aspect, the amount of copper source present in the mixture can be an amount necessary to provide a copper ion concentration in the mixture and/or ultimately in the zinc sulfide lattice of from about 800 ppm to about 2,000 ppm, for example, about 800, 900, 1,000, 1,200, 1,400, 1,600, 1,800, or, 2,000 ppm; or from about 1,000 ppm to about 1,800 ppm, for example, about 1,000, 1,100, 1,200, 1,300, 1,400, 1,500, 1,600, 1,700, or 1,800 ppm. In still other aspects, the amount of copper ion present in the mixture can be less than about 800 ppm or greater than about 2,000 ppm, and the present invention is not intended to be limited to a particular copper concentration. In one aspect, the amount of copper or copper source material present in the mixture can be an amount suitable to saturate or nearly saturate a ZnS lattice with copper when a flux material is used in accordance with the present invention. It should be appreciated that the amount of copper source and/or copper ions can vary depending on, for example, the desired copper concentration in the final phosphor material, the desired color emission, and/or other phosphor properties. It should also be appreciated that, in accordance with the teachings of the present invention, the amount of copper necessary to produce a phosphor having a desired copper concentration can vary depending on the particular flux material and concentration thereof used in the preparation of the phosphor. Copper source materials are commercially available and one of skill in the art could readily select an appropriate copper source material.

A magnesium source of the present invention can comprise any magnesium compound suitable for use in forming an electroluminescent phosphor. In one aspect, the magnesium source comprises a magnesium compound that does not degrade or substantially degrade a phosphor property, such as, for example, brightness and lifetime. In a specific aspect, the magnesium source comprises a magnesium chloride. In one aspect, the magnesium source comprises a powdered magnesium chloride. In another aspect, the magnesium source is anhydrous or substantially anhydrous. The amount of magnesium source present in the mixture can also vary depending on the desired properties of the final phosphor material. In various aspects, the amount of magnesium source present in the mixture can range from about 1 wt. % to about 10 wt. %, for example, about 1, 1.5, 2, 2.5, 3, 4, 5, 6, 7, 8, 9, or 10 wt. %; from about 3 wt. % to about 8.5 wt. %, for example, about 3, 3.5, 4, 4.5, 5, 5.5, 6, 6.5, 7, 7.5, 8, or 8.5 wt. %; or from about 4.5 to about 7.5 wt. %, for example, about 4.5, 5, 5.5, 6, 6.5, 7, or 7.5 wt. %. In various aspects, a magnesium chloride is present in the mixture at about 3.2, 3.8, 4.2, 4,6, 5,1, 5,5, 5,7, 6, 6.4, 6.9, 7.3, 7.7, 8.0, 8.2, or 8.4 wt. %. In other aspects, the amount of magnesium source present in the mixture can be less than about 1 wt. % or greater than about 10 wt. %, and the present invention is not intended to be limited to any particular magnesium source concentration. Magnesium source materials, such as, for example, magnesium chloride, are commercially available and one of skill in the art could readily select an appropriate magnesium source material for use with the present invention.

The sulfur of the present invention can comprise any sulfur material suitable for use in forming an electroluminescent phosphor. In one aspect, the sulfur material comprises a powder. While not wishing to be bound by theory, the presence of sulfur can reduce and/or prevent the oxidation of zinc sulfide when heated and/or fired in an oxidizing environment, such as air. If sulfur is not present during heating and/or firing, at least a portion of the zinc sulfide can, in various aspects, be sacrificed to absorb oxygen during the heating and/or firing process. The amount of sulfur present in the mixture can also vary depending on the desired properties of the final phosphor material. In various aspects, the amount of sulfur present in the mixture can range from about 0 to about 15 wt. %, for example, about 0, 0.5, 0.7, 0.9, 1, 1.5, 2, 2.5, 3, 4, 5, 6, 7, 8, 9, 10, 11, 12, 13, 14, or 15 wt. %; fromabout 0.5 to about 10wt. %, for example, about 0.5, 0.8, 1, 1.2, 1.4, 1.6, 1.8, 2, 3, 4, 5, 6, 7, 8, 9, or 10 wt. %; or from about 1 to about 6 wt. %, for example, about 1, 2, 3, 4, 5, or 6 wt. %. In other aspects, the amount of sulfur present in the mixture can be greater than about 15 wt. %, and the present invention is not intended to be limited to any particular sulfur concentration. Sulfur materials are commercially available and one of skill in the art could readily select an appropriate sulfur material to prepare an electroluminescent phosphor.

The lithium halide of the present invention can comprise any lithium halide material suitable for use in forming an electroluminescent phosphor. In one aspect, the lithium halide comprises a lithium chloride. In another aspect, the lithium halide comprises a powder. The amount of lithium halide present in the mixture can also vary depending on, for example, the desired properties of the final phosphor material. In various aspects, the amount of lithium halide present in the mixture can range from about 0. 1 wt. % to about 2 wt. %, for example, about 0.1, 0.15, 0.2, 0.3, 0.4, 0.6, 0.8, 1, 1.5, or 2 wt. %; or from about 0.5 wt. % to about 1.2 wt. %, for example, about 0.5, 0.7, 0.9, 0.1, 0.15, 0.18, 0.2, 0.25, 0.3, 0.5, 0.6, 0.7, 0.9, 1.0, 1.1, or 1.2 wt. %. In various aspects, the amount of lithium halide present can comprise about 0.5, 0.7, 0.9, 1.1, or 1.2 wt. %. In other aspects, the amount of lithium halide can be less than about 0.1 wt. % or greater than about 2 wt. %, and the present invention is not limited to any particular lithium halide concentration. In other aspects, a lithium halide, such as, for example, lithium chloride, can replace at least a portion of other materials that would otherwise be present in the mixture, such as, for example, sodium chloride. In still other aspects, the amount of lithium halide present in the mixture can vary depending on, for example, the amount of copper to be distributed in the ZnS lattice. Lithium halide materials are commercially available and one of skill in the art could readily select an appropriate lithium halide material.

The sodium chloride of the present invention, if present, can comprise any sodium chloride suitable for use in forming an electroluminescent phosphor. In one aspect, the sodium chloride comprises a powder. The amount of sodium chloride present in the mixture can also vary depending on the desired properties of the final phosphor material. In various aspects, the amount of sodium chloride present in the mixture can range from 0 wt. % to about 4 wt. %, for example, about 0, 0.1, 0.2, 0.3, 0.5, 0.7, 0.9, 1, 1.2, 1.4, 1.6, 1.8, 2, 2.2, 2.4, 2.6, 2.8, 3, 3.2, 3.4, 3.6, 3.8, or 4 wt. %; or from 0 wt. % to about 1.5 wt. %, for example, about 0, 0.1, 0.2, 0.3, 0.5, 0.7, 0.9, 1, 1.2, 1.4, or 1.5 wt. %. In a specific aspect, the amount of sodium chloride present in the mixture is about 1.2 wt. %.

The barium chloride of the present invention, if present, can comprise any barium chloride suitable for use in forming an electroluminescent phosphor. In one aspect, the barium chloride comprises a powder. The amount of barium chloride present in the mixture can also vary depending on the desired properties of the final phosphor material. In various aspects, the amount of barium chloride present in the mixture can range from 0 wt. % to about 3 wt. %, for example, about 0, 0.1, 0.2, 0.3, 0.5, 0.7, 0.9, 1, 1.2, 1.4, 1.6, 1.8, 2, 2.2, 2.4, 2.6, 2.8,or 3 wt. %; or from 0 wt. % to about 1.5 wt. %, for example, about 0, 0.1, 0.2, 0.3, 0.5, 0.7, 0.9, 1, 1.2, 1.4, or 1.5 wt. %. In a specific aspect, the amount of sodium chloride present in the mixture is about 1.2 wt. %.

In various aspects, each of the alkali and alkaline earth chlorides that are present in the mixture can serve as a flux material to promote crystal growth and/or as a co-activator source.

In one aspect, the mixture comprises from about 70 to about 98 wt. % zinc sulfide, from about 0 to about 1 wt. % zinc oxide, from about 0.01 to about 1 wt. % of a copper source; from about 1 to about 10 wt. % of a magnesium source; from about 0 to about 15 wt. % sulfur; from about 0.1 to about 2 wt. % of a lithium halide; from about 0 to about 4 wt. % of sodium chloride, and from about 0 to about 3 wt. % barium chloride. In another aspect, the mixture comprises from about 79 to about 92 wt. % zinc sulfide, from about 0.2 to about 0.6 wt. % zinc oxide, from about 0.06 to about 0.4 wt. % of a copper source, from about 3 to about 8.5 wt. % of a magnesium source, from about 0.5 to about 10 wt. % sulfur, from about 0.5 to about 2 wt. % lithium halide, from about 0 to about 1.5 wt. % sodium chloride, and from 0 to about 1.5 wt. % barium chloride. In yet another aspect, the mixture comprises from about 83 to about 88 wt. % zinc sulfide, from about 0.3 to about 0.5 wt. % zinc oxide, from about 0.1 to about 0.3 wt. % of a copper source, from about 4.5 to about 7.5 wt. % of a magnesium source, from about 1 to about 6 wt. % sulfur, from about 0.5 to about 1.2 wt. % lithium halide, from about 0 to about 1.5 wt. % sodium chloride, and from about 0 to about 1.5 wt. % barium chloride. In a specific exemplary aspect, the mixture comprises about 83.25 wt. % zinc sulfide, about 0.45 wt. % copper (II) sulfate, about 7 wt. % magnesium chloride, about 8.3 wt. % sulfur, and about 1 wt. % lithium chloride.

In one aspect, each of the zinc sulfide, copper source, magnesium source, lithium halide, and optional zinc oxide, sulfur, sodium chloride, and barium chloride are contacted to form a mixture. In another aspect, each of the components in the mixture are blended together. In a specific aspect, each of the components in the mixture are blended so as to achieve a uniform or substantially uniform mixture, wherein each of the components is distributed uniformly or substantially uniformly throughout the mixture. The order of contacting and/or mixing of each of the individual components is not important. In one aspect, all of the components to be present in the mixture are contacted together. In another aspect, the zinc sulfide can initially be contacted with all or a portion of the copper source prior to contacting with other components so as to form, for example, a CuS coating on at least a portion of the zinc sulfide particles and/or so as to homogeneously or substantially homogeneously distribute copper ions throughout the zinc sulfide material. In such an aspect, the copper contacted zinc sulfide can optionally be dried and subsequently contacted with the remaining components.

After contacting the components to form a mixture, the mixture is heated at a time and temperature sufficient to at least partially ceram the mixture. In another aspect, the mixture is heated at a time and temperature sufficient to incorporate at least portion of the flux component, such as lithium ions from the lithium chloride, into the zinc sulfide lattice. In one aspect, the mixture is heated at a time and temperature sufficient to create one or more crystalline domains in the mixture. In another aspect, the mixture is heated at a time and temperature sufficient to ceram all or substantially all of the mixture. In various aspects, the temperature for firing the mixture can be from about 1,020° C. to about 1,400° C., for example, about 1,020, 1,050, 1,100, 1,150, 1,200, 1,250, 1,300, 1,350, or 1,400° C.; or from about 1,050° C. to about 1,250° C., for example, about 1,050, 1,100, 1,150, 1,200, 1,250° C. In other aspects, the temperature at which the mixture is heated can be less than about 1,020° C. or greater than about 1,400° C., and the present invention is not intended to be limited to any particular firing temperature. In various aspects, the mixture can be fired for a period of from about 30 minutes to about 24 hours, for example, about 30 minutes, 45 minutes, or 1, 2, 3, 4, 5, 6, 8, 10, 12, 14, 16, 18, 20, 22, or 24 hours; or from about 1 to about 5 hours, for example, about 1, 2, 3, 4, or 5 hours. In still other aspects, the time for which a mixture is fired can be less than about 30 minutes or greater than about 24 hours, and the present invention is not intended to be limited to any particular firing time. In a specific aspect, the mixture is heated to a temperature of at least about 1,020° C. for a period of at least about 1 hour. In another aspect, the mixture is heated at a temperature and for a time sufficient to transform at least a portion of the zinc sulfide from a cubic lattice structure to a hexagonal lattice structure. In yet another aspect, the mixture is heated at a temperature and for a time sufficient to transform all or substantially all of the zinc sulfide from a cubic lattice structure to a hexagonal lattice structure. It should be appreciated that the time and temperature at which the mixture is fired can vary depending upon, for example, the specific materials and concentrations thereof in the mixture. It should also be appreciated that the time and temperature at which the mixture is fired can be related such that firing at a higher temperature can require a shorter period of time, and firing for an extended period can be performed at a lower temperature. One of skill in the art could readily select appropriate times and temperatures for firing a mixture. After firing, the fired mixture can optionally be cooled by, for example, allowing the fired mixture to slowly cool in a heated environment such as a furnace, allowing the fired mixture to naturally cool to ambient temperature without additional cooling means, or by employing a cooling means, such as, for example, a fan, to reduce the temperature such that the fired mixture can be handled. In one aspect, a fired mixture is slowly cooled in a furnace. In another aspect, a fired mixture is cooled using a cooling means such as a fan. In yet another aspect, a fired mixture is cooled by allowing the mixture to cool to ambient without additional cooling means.

After firing, the fired mixture can optionally be washed with hot deionized water to remove at least a portion of any flux residuals that remain on the phosphor surface. If so washed, the fired mixture can be dried at about 120° C. for about 15 to 16 hours, and then sifted through, for example, a 100 mesh screen. In one aspect, a fired mixture is not washed with hot deionized water. In another aspect, a fired mixture is washed with hot deionized water to remove at least a portion of any remaining flux from the phosphor surface. In yet another aspect, a fired mixture is washed with hot deionized water until all or substantially all of any remaining flux is removed from the phosphor surface.

The resulting powder can then be mechanically worked to induce one or more defects in the crystal structure. In one aspect, the fired mixture can be subjected to a shear force, for example, by milling, capable of inducing a plurality of defects in the zinc sulfide lattice structure. In another aspect, the fired mixture can be milled so as to induce a plurality of defects in the crystal structure. In various aspects, milling can be performed with any milling technique suitable for use in preparing an electroluminescent phosphor. In various aspects, milling can be performed with a muller, a media mill, dispersion mill, ball mill, and/or other milling techniques or combinations thereof. The specific milling technique and conditions (e.g., time) can vary depending upon, for example, the desired particle size distribution, degree of homogeneity desired in the milled mixture, and volume of fired mixture being milled. In one aspect, the milling technique induces a shear force onto at least a portion of the fired particles so as to create lattice defects. In one aspect, a fired mixture is milled in a lab scale muller. In another aspect, a fired mixture, for example about 500 g of a fired mixture, is milled for a period of from about 75 to about 150 minutes.

After milling, the resulting powder can optionally be washed to remove all or a portion of any flux and/or copper sulfide residues that may be present on the phosphor surface. In one aspect, a wash can comprise a cyanide compound, such as, for example, potassium cyanide, to wash the surface of a phosphor material. In another aspect, a wash can comprise an acid wash, a base wash, a deionized water wash, or a combination thereof. Such a wash composition can avoid environmental and health concerns associated with a cyanide wash composition. In a specific aspect, a washing step can be performed with an acidic solution, followed by a wash with a basic solution, and then followed by a deionized water wash. In a specific aspect, an acidic wash can comprise diethylene triamine pentaacetic acid (“DTPA”). In another specific aspect, a base solution can comprise a sodium hydroxide solution. In a specific aspect, the resulting powder is subjected to a DTPA-NaOH—H₂O₂ wash. The composition of a DTPA-NaOH—H₂O₂ wash can vary, and in various aspects, can comprise from about 4 to about 9 wt. % DTPA, from about 2 to about 5.6 wt. % NaOH, and from about 7.8 to about 15 wt. % of a 35% H₂O₂ solution, with the remaining balance comprising water, such as, for example, cold deionized water. The specific concentrations of any individual wash component can vary, such as for example by increasing the amount of DTPA and NaOH, and the present invention is not intended to be limited to any specific wash composition. In a specific aspect, a wash solution can comprise about 4.5% DTPA, about 2.8 wt. % NaOH, and about 12.9 wt. % H₂O₂ (35% solution). In another aspect, the amount of cold deionized water utilized in a wash composition comprises about three times the weight of phosphor powder being washed. In yet other aspects, the phosphor powder can be subjected to one or more deionized water washes either alone or in addition to any other wash steps. A deionized water wash, if performed, can be performed with hot water. In one aspect, a deionized water wash can be continued until the pH of the resulting slurry is lower than about 7. After washing, a phosphor powder can optionally be dried, such as, for example, in an oven at 120° C. for about 15 to 16 hours, prior to use or further processing.

After milling and any optional washing steps, the resulting phosphor powder can be contacted with additional copper source and zinc oxide material to form a second mixture. In various aspects, each of the copper source and/or zinc oxide can comprise the same or different chemical compositions, physical form and size as the copper source and zinc oxide present in the first mixture. In a specific aspect, the copper source is the same material as the copper source present in the first mixture. In another specific aspect, the copper source is a different material than the copper source in the first mixture. In still another aspect, the copper source present in the second mixture comprises at least the copper source present in the first mixture and at least one additional copper source. Similarly, the zinc oxide can comprise the same or different chemical composition or physical form than the zinc oxide present in the first mixture. In one aspect, the concentration of the copper source present in the second mixture can comprise from about 0.2 to about 0.8 wt. % based on the amount zinc sulfide, for example, 0.2, 0.3, 0.4, 0.5, 0.6, 0.7, or 0.8 wt. % based on the amount of zinc sulfide; or from about 0.3 to about 0.5 wt. % based on the amount of zinc sulfide, for example, about 0.3, 0.35, 0.4, 0.45, or 0.5 wt. % based on the amount of zinc sulfide. In a specific aspect, the second mixture comprises about 0.47 wt. % of a copper source based on the amount of zinc sulfide, such as, for example, copper (II) sulfate. In another aspect, the concentration of zinc oxide presenting the second mixture can comprise from about 5 to about 20 wt. % based on the amount of zinc sulfide, for example, about 5, 6, 7, 8, 9, 11, 13, 15, 17, 19, or 20 wt. % based on the amount of zinc sulfide; or from about 8 to about 13 wt. % based on the amount of zinc sulfide, for example, about 8, 9, 10, 11, 12, or 13 wt. % based on the amount of zinc sulfide. In a specific aspect, the second mixture comprises about 10 wt. % zinc oxide based on the amount of zinc sulfide present. In yet other aspects, the amount of a copper source and/or a zinc oxide can be less than or greater than any amounts specifically recited herein, and the present invention is not intended to be limited to any particular copper source and/or zinc oxide concentration.

After forming the second mixture, the mixture can be heated again. In one aspect, the second mixture is heated at a temperature lower than the temperature of the first firing. In another aspect, the second mixture is heated for a time and at a temperature sufficient to incorporate at least a portion of the additional copper source present in the second mixture into the zinc sulfide lattice. In various aspects, the second mixture can be heated at a temperature of from about 700° C. to about 850° C., for example, about 700, 725, 750, 775, 800, 825, or 850° C., for a period of from about 1 to about 4 hours, for example, 1, 1.5, 2, 2.5, 3, 3.5, or 4 hours. In other aspects, the second mixture can be heated at a temperature less than about 700° C. or greater than about 850° C., and/or for a period of less than about 1 hour or greater than about 4 hours, and the present invention is not intended to be limited to any particular time and temperature.

After heating, the second mixture can optionally be cooled by, for example, allowing the fired mixture to slowly cool in a heated environment such as a furnace, allowing the fired mixture to naturally cool to ambient temperature without additional cooling means, or by employing a cooling means, such as, for example, a fan, to reduce the temperature such that the fired mixture can be handled. In one aspect, a fired mixture is slowly cooled in a furnace. In another aspect, a fired mixture is cooled using a cooling means such as a fan. In yet another aspect, a fired mixture is cooled by allowing the mixture to cool to ambient without additional cooling means.

After heating and optionally cooling the second mixture sample, the mixture can optionally be washed to remove any remaining residues that may be present on the surface of the phosphor particles. In one aspect, a washing step, if performed, can be the same or substantially the same as that described herein for washing the fired first mixture. In another aspect, a washing step, if performed, can comprise a different procedure (e.g., wash solution, composition, conditions) than that described herein for the fired first mixture. If washed, the second mixture can optionally be dried or subjected to conditions sufficient to dry or substantially dry the phosphor mixture.

Once prepared, the resulting phosphor mixture can optionally be subjected to other processing steps to, for example, mill and/or sift the phosphor powder.

### High Copper Content ZnS:Cu Electroluminescent Phosphor

In various aspects, the phosphor materials produced by the methods of the present invention can exhibit a high copper concentration and can provide a high y color coordinate.

The copper content of a phosphor produced in accordance with the various aspects of the present invention can be higher or substantially higher than that attainable through conventional phosphor preparation means. For example, a phosphor produced by the present invention can comprise greater than about 1,000 ppm copper. In another aspect, a phosphor produced by the methods of the present invention can comprise at least about 1,000, 1,100, 1,200, 1,300, 1,400, 1,500, 1,600, 1,700, or 1,800 ppm copper.

The phosphor produced by the methods of the present invention can, in various aspects, also exhibit a high y color coordinate value, for example, at least about 0.480, at least about 0.490, at least about 0.500, at least about 0.510, or at least about 0.520. In addition, in various aspects, such a phosphor can exhibit an x color coordinate of from about 0. 180 to about 0.200.

### Applications

The inventive high copper content zinc sulfide electroluminescent phosphor of the present invention can be useful in a variety of devices requiring or benefiting from a light emitting phosphor having a high y color coordinate, such as, for example, electroluminescent display devices.

Although several aspects of the present invention have been described in the detailed description, it should be understood that the invention is not limited to the aspects disclosed, but is capable of numerous rearrangements, modifications and substitutions without departing from the spirit of the invention as set forth and defined by the following claims.

### EXAMPLES

To further illustrate the principles of the present invention, the following examples are put forth so as to provide those of ordinary skill in the art with a complete disclosure and description of how the glass compositions, articles, devices, and methods claimed herein are made and evaluated. They are intended to be purely exemplary of the invention and are not intended to limit the scope of what the inventors regard as their invention. Efforts have been made to ensure accuracy with respect to numbers (e.g., amounts, temperatures, etc.); however, some errors and deviations should be accounted for. Unless indicated otherwise, temperature is ° C. or is at ambient temperature, and pressure is at or near atmospheric. There are numerous variations and combinations of process conditions that can be used to optimize product quality and performance. Only reasonable and routine experimentation will be required to optimize such process conditions.

Lamp data was measured using a screen printing method. The brightness data are given as relative values (%) to a lamp standard recorded when the lamp had been operated at 100 V and 400 Hz for 24 hours. Maintenance data were obtained by using the following formula: (Brightness at 100 h/Brightness at 24 h)×100%. All examples given below were washed before final analysis, in the manner described in Example 2 so as to ensure that the measured Cu concentration for each sample represents the true Cu level in the bulk particles and not including any surface deposits of unwashed Cu containing species.

### Example 1

### Lamp Preparation and Analysis

In a first example, a lamp for testing a phosphor material can be prepared using a screen printing method. An electroluminescent phosphor powder can be mixed with a binder, such as, for example, a Luxprint® 8155 vehicle, available from DuPont Microcircuit Materials, E. I. du Pont de Nemours and Company, Wilmington, Del., USA. The phosphor powder can comprise about 60 wt. % of the mixture, and the resulting phosphor suspension can be screen printed onto a thick polyethylene terephthalate (PET) film (e.g., about 0.0065 to 0.0075 in.) having a transparent, conductive layer of indium tin oxide (ITO), for example, an OC-200 film available from CPFilms, St. Louis, Mo., USA. The printing screen can be a polyester printing screen having 137 or 140 threads per inch. The screen printed phosphor layer can be dried in an oven, and the dried film positioned again under the printing screen.

An insulating, dielectric layer can be formed over the phosphor layer by multiple (e.g., two) applications of a barium titanate filled ink, such as Luxprint® 8153 dielectric paste, available from DuPont Microcircuit Materials, E. I. du Pont de Nemours and Company, Wilmington, Del., USA. After each application, the dielectric layer can be dried in an oven. A rear conductive electrode, such as, for example, Luxprint 8144® Carbon Paste, available from DuPont Microcircuit Materials, E. I. du Pont de Nemours and Company, Wilmington, Del., USA, can then be applied over the dielectric layer and dried in an oven. Alternatively, other printable, conductive inks, such as silver, carbon-silver, or nickel containing inks can be used.

In lieu of screen printing, other suitable techniques can be employed such as a doctor blade or draw blade coating, tape casting, roll-to-roll coating, or a combination thereof.

Lamps prepared via a screen printing or other technique can be tested for, among other properties, luminance and maintenance. Lamps can be tested in a constant humidity chamber. In some aspects, the rear electrode of a lamp can be covered by, for example, a pressure-sensitive adhesive tape (e.g., 3M Scotch 821 tape) to prevent liquid water from entering the lamp assembly. Lamps can be operated for about 24 hours prior to measuring brightness so as to allow the lamp to stabilize and thus, obtain representative measurements.

### Example 2

### Comparative ZnS:Cu Phosphor (A)

In a second example, a comparative (non-inventive) ZnS phosphor was prepared. The comparative phosphor was prepared by blending 520.0 g of ZnS (not pre-doped with Cl) with 1.122 g (equivalent to 843 ppm of Cu) of anhydrous copper sulfate (CuSO₄), 5.30 g (1%) of sodium chloride (NaCl), 37.10 g (7%) of magnesium chloride (MgCl₂, anhydrous), 2.75 g (0.52%) of zinc oxide (ZnO), and 22.00 g (4.15%) of sulfur (S) powder. The mixture was then fired in air using covered silica crucibles at 1,150° C. for 3.5 hours. After cooling, the material was water washed, dried, sifted through a 100 mesh screen, and then mulled. After mulling, the material was washed with hydrochloric acid solution and then a basic solution containing 4.5% DTPA, 2.8% NaOH, and 12.9% of H₂O₂ (35%). The material was washed with deionized water several times to remove any remaining chemical residues and was then dried. After drying, 100 g of the material was blended with, relative to the phosphor weight, 0.47% of anhydrous CuSO₄ and 10% of ZnO. The blended material was then fired a second time in air at 735° C. for 2 hours and 17 minutes and then slowly cooled. The fired material was washed with hot deionized water, at least once with hydrochloric acid, and at least twice with the basic solution of DTPA-NaOH—H₂O₂ as mentioned above. After several water washes to remove remaining chemical residues, the material was dried and sifted to form a normal green emitting EL phosphor.

### Example 3

### Comparative ZnS:Cu Phosphor (B)

In a third example, another comparative phosphor was prepared. The second comparative ZnS:Cu phosphor was prepared according to the procedure described in Example 2, except that: (a) 1,200 ppm (0.12%) of Cu (instead of 843 ppm) and 8.30% (instead of 4.15%) of sulfur were added in the first firing step, and (b) firing was done at 1,200° C. for 1.5 hours. As illustrated in Table 1, below, the resulting product had a Cu concentration of only 990 ppm while 1,200 ppm was initially added, indicating that the ZnS became saturated with Cu. The color of the material after the first firing step was gray, indicating that excessive Cu formed CuₓS and remained on the surface of the ZnS:Cu particles.

TABLE 1
Comparative Example Data

| | Example 2 (A) | Example 3 (B) |
|---|---|---|
| Cu doped in first firing step (ppm) | 843 | 1,200 |
| Powder body color after first firing step | Gray | Dark gray |
| D50 (μm) | 24.50 | 26.55 |
| Maintenance % (100 h/24 h) * 100 | 94.5 | 94.7 |
| % of ref @ 24 hr | 118 | 99.4 |
| 24 h Brt (cd/m²) | 97.9 | 77.4 |
| Color x | 0.181 | 0.190 |
| Color y | 0.473 | 0.499 |
| Final Cu (ppm) | 760 | 990 |

As described herein, when a copper doping level is increased from 843 ppm to 1,200 ppm, the powder color was darker, indicating that more copper remained on the surface of the particle, such as in the form of CuₓS. Elemental analysis of the final phosphor materials revealed 990 ppm Cu for Example 3 (Comparative Phosphor B), less than the amount originally added.

### Example 4

### Inventive ZnS:Cu Phosphor (A)

In a fourth example, an inventive ZnS:Cu phosphor was prepared. The inventive phosphor was prepared in accordance with the procedure described in Example 3, except that 28% of the NaCl (about 1.50 g out of 5.30 g) was replaced by LiCl, and the initial Cu addition was 1,080 ppm (0. 108%). As illustrated in the data in Table 2, below, the Cu concentration in the final product was 1,100 ppm, indicating that the Cu added initially was fully incorporated into the ZnS lattices. Thus, although the inventive phosphor had less Cu added initially (1,080 ppm) as compared to that in Example 3 (1,200 ppm), the inventive phosphor exhibited a higher Cu concentration in the final product, demonstrating that the addition of LiCl facilitated the entrainment of Cu within the ZnS lattice. The color of the material resulting after the first firing step was a light green-gray (not gray), indicating that no excessive CuₓS had formed on the surface of the ZnS:Cu particles.

### Example 5

### Inventive ZnS:Cu Phosphor (B)

In a fifth example, another inventive ZnS:Cu phosphor was prepared. This inventive phosphor was prepared in accordance with Example 4, except that: (a) 2% of LiCl and 6% of MgCl₂ were used, (b) initial Cu addition was 1,200 ppm (0.12%), and (c) the first firing step was performed at 1,200° C. for 1.5 hours. In this example, the weight ratio of LiCl in the total flux was increased over that in Example 4. The color of the material after the first firing step was still yellow green. Traditional methods employing such a high amount of Cu without a Li containing flux component would result in a dark gray particle surface. As illustrated in Table 2, the Cu concentration in the final product was 1,300 ppm, indicating that the initially added Cu was well incorporated in the ZnS lattice.

### Example 6

### Inventive ZnS:Cu Phosphor (C)

In a sixth example, still another inventive ZnS:Cu phosphor was prepared. This inventive material was prepared in accordance with Example 5, except that the initial Cu addition was further increased to 1,800 ppm (0. 18%). The color of the material after the first firing step was gray, indicating that the ZnS lattice became saturated with Cu at this doping level. As illustrated in Table 2, the Cu concentration in the final product was 1,600 ppm, indicating that only a small portion of the initially added Cu was not incorporated into the ZnS lattice. Thus, the saturation level of Cu was much higher in the presence of LiCl than that described in Example 2 wherein no LiCl was used. The y color coordinate reached to 0.520 in this example.

TABLE 2
Inventive Examples Data

| | Example 4 | Example 5 | Example 6 |
|---|---|---|---|
| | (A) | (B) | (C) |
| Cu doped in first firing step (ppm) | 1,080 | 1,200 | 1,800 |
| Powder body color after first | Lt green | Yellow | Dark |
| firing step | gray | green | gray |
| D50 (μm) | 27.23 | 26.94 | 27.01 |
| Maintenance % (100 h/24 h) * 100 | 92.4 | 91.9 | 91.7 |
| % of ref @ 24 hr | 118 | 105 | 91 |
| 24 h Brt (cd/m²) | 108 | 81.4 | 70.9 |
| Color x | 0.184 | 0.187 | 0.200 |
| Color y | 0.482 | 0.491 | 0.520 |
| Final Cu (ppm) | 1,100 | 1,200 | 1,600 |

In Example 5 (Inventive Phosphor B), the copper originally added to the mixture was well retained in the final material, especially as compared to the comparative phosphors in Examples 2 and 3. Thus, the lithium chloride used in Example 5 facilitated the doping of copper ions into the zinc sulfide lattice. In Example 6 (Inventive Phosphor C), the copper concentration in the final phosphor material would not have been obtainable without the addition of a lithium halide, in accordance with the various aspects of the present invention.

Throughout this application, various publications are referenced. The disclosures of these publications in their entireties are hereby incorporated by reference into this application in order to more fully describe the compositions, articles, device, and methods described herein.

Various modifications and variations can be made to the compositions, articles, devices, and methods described herein. Other aspects of the compositions, articles, devices, and methods described herein will be apparent from consideration of the specification and practice of the compositions, articles, devices, and methods disclosed herein. It is intended that the specification and examples be considered as exemplary.

What is claimed is:

1. A copper activated zinc sulfide electroluminescent phosphor comprising greater than about 1,000 ppm copper.

2. The copper activated zinc sulfide electroluminescent phosphor of claim 1, comprising at least about 1,100 ppm copper.

3. The copper activated zinc sulfide electroluminescent phosphor of claim 1, comprising at least about 1,300 ppm copper.

4. The copper activated zinc sulfide electroluminescent phosphor of claim 1, comprising at least about 1,600 ppm copper.

5. The copper activated zinc sulfide electroluminescent phosphor of claim 1, comprising a zinc sulfide lattice, and wherein all or substantially all of the copper is present within the zinc sulfide lattice.

6. The copper activated zinc sulfide electroluminescent phosphor of claim 1, having a y color coordinate of at least about 0.480.

7. The copper activated zinc sulfide electroluminescent phosphor of claim 1, having a y color coordinate of at least about 0.490.

8. The copper activated zinc sulfide electroluminescent phosphor of claim 1, having a y color coordinate of at least about 0.500.

9. The copper activated zinc sulfide electroluminescent phosphor of claim 1, having a y color coordinate of at least about 0.520.

10. The copper activated zinc sulfide electroluminescent phosphor of claim 1, comprising from about 1,100 ppm to about 1,600 ppm copper and having a y color coordinate of from about 0.480 to about 0.520.

11. The copper activated zinc sulfide electroluminescent phosphor of claim 1, having an x color coordinate of from about 0.180 to about 0.200.

12. A method for preparing a copper activated zinc sulfide electroluminescent phosphor, the method comprising:
a) contacting a zinc sulfide, a first copper source, a magnesium source, and a lithium halide to form a first mixture;
b) heating the first mixture at a temperature and for a time sufficient to form a fired mixture;
c) subjecting the fired mixture to a shear force capable of inducing a plurality of defects in the zinc sulfide lattice structure; and then
d) contacting the fired mixture with a second copper source and a zinc oxide to form a second mixture; and then
e) heating the second mixture at a temperature and for a time sufficient to form a second-fired material.

13. The method of claim 12, wherein step a) comprises contacting a zinc sulfide, a first copper source, a magnesium source, a lithium halide, and at least one of a zinc oxide, sulfur, sodium chloride, barium chloride, or a combination thereof.

14. The method of claim 12, wherein heating the first mixture comprises heating at a temperature of at least about 1,020° C. for a period of for at least about 1 hour.

15. The method of claim 12, wherein heating the first mixture comprises heating at a temperature and for a time sufficient to transform at least a portion of the zinc sulfide from a cubic lattice structure to a hexagonal lattice structure.

16. The method of claim 12, further comprising washing at least one of the first mixture, the second mixture, or a combination thereof, to remove at least a portion of any flux and/or copper sulfide remaining on the phosphor surface.

17. The method of claim 16, comprising washing both the first mixture and the second mixture to remove at least a portion of any flux and/or copper sulfide remaining on the phosphor surface.

18. The method of claim 16, wherein washing comprises contacting the fired mixture with an acidic solution and then with a basic solution.

19. The method of claim 12, wherein the first copper source and the second copper source comprise the same composition.

20. The method of claim 12, wherein heating the second mixture comprises heating at a temperature of from about 700° C. to about 850° C. for a period of at least about 1 hour.
